(19) United States
(12) Patent Application Publication
(10) Pub. No.: US 2026/0081407 A1
(43) Pub. Date: Mar. 19, 2026

(54) HOUSING ASSEMBLY FOR AN ELECTRICAL COMPONENT

(71) Applicant: STÄUBLI ELECTRICAL CONNECTORS AG, Allschwil (CH)

(72) Inventors: Lee Michael WADE, Windsor, CA (US); Brian Wade MILLS, Santa Rosa, CA (US); Dustin Delmar Reede CARVER, Windsor, CA (US)

(73) Assignee: STÄUBLI ELECTRICAL CONNECTORS AG, Allschwil (CH)

(21) Appl. No.: 19/106,471

(22) PCT Filed: Aug. 22, 2023
(86) PCT No.: PCT/EP2023/072990

§ 371 Date: Feb. 25, 2025

Related U.S. Application Data
(60) Provisional application No. 63/401,313, filed on Aug. 26, 2022.
(60) Provisional application No. 63/401,333, filed on Aug. 26, 2022.

(51) Int. Cl. H02G 3/06; H02G 15/013; H02G 15/10

(52) U.S. Cl. CPC H02G 3/0616; H02G 15/013; H02G 15/10

(57) ABSTRACT

A housing assembly for an electrical component having a housing with a housing wall extending at least partly around a middle axis and defining an interior space in which said electrical component can be placed, and at least one cable gland which can be mounted to the housing along a mounting direction. The at least one cable gland is mounted by a snap-in connection to the housing. The snap-in connection has at least one groove having a groove side stop surface and at least one cam having a cam side stop surface. In the mounted position the at least one cam engages in the at least one groove and the groove side stop surface is in contact with the cam side stop surface.

### TECHNICAL FIELD

The present invention relates to a housing assembly for an electrical component according to claim 1 and an assembly according to claim 15.

### PRIOR ART

From prior art cable glands are known which are fitted by means of a thread to a housing in which an electrical component is arranged.

### SUMMARY OF THE INVENTION

It is an object of the present invention to provide a housing assembly for an electrical component having an alternative structure to mount a cable gland to the housing.

This object is solved by claim 1. Accordingly, a housing assembly for an electrical component comprises a housing with a housing wall extending at least partly around a middle axis and defining an interior space in which said electrical component can be placed and at least one cable gland which can be mounted to the housing along a mounting direction. Said at least one cable gland is mounted by means of a snap-in connection to the housing. Said snap-in connection comprising at least one groove having a groove side stop surface and at least one cam having a cam side stop surface. In the mounted position said at least one cam engages in said at least one groove and wherein said groove side stop surface is in contact with said cam side stop surface.

With the snap-in connection an alternative mounting structure is provided. Said mounting structure has additionally the advantage that the cable gland can be mounted along a longitudinal direction which makes the mounting process easier.

The housing as well as the cable gland are preferably provided by an electrically isolated material.

The contact between the stop surfaces is provided such that movement of the cable gland 5 against the mounting direction is prevented.

Preferably said at least one groove extends circumferentially around said middle axis over the complete circumference. This has the advantage that no angular alignment between the cable gland and the housing is necessary.

Preferably an angularly inclined ramp section is arranged before the groove as seen in mounting direction, wherein the angularly inclined ramp section is provided such that the diameter of the angularly inclined ramp section increases with decreasing distance to said groove.

Preferably, said angularly inclined ramp section is inclined at an angle of 10° to 45°, in particular 15° to 35°, to the middle axis.

In a preferred embodiment exactly one groove is arranged.

Preferably at least two or at least three or exactly three of said cams are arranged, which cams are distributed in regular distances around the circumference around said middle axis.

Preferably, said at least one cam comprises an angularly inclined ramp section which is arranged such that the diameter increases with increasing distance to said cam side stop surface.

Preferably said angularly inclined ramp is inclined at an angle of 20° to 40°, in particular 25° to 35°, to the middle axis.

In a first variant said angularly inclined ramp sections have the same angle with respect to said middle axis. In a further variant said angularly inclined ramp section located at the groove has a larger or smaller angle with respect to the middle axis as said angularly inclined ramp section located at the cam.

Preferably, said groove side stop surface is in a flat contact with said cam side stop surface.

Preferably, the overlap of the groove side stop surface and the cam side stop surface is at least 0.75 millimeter annularly, in particular at least 1 millimeter annularly. These dimensions are particularly advantageous, when the diameter of the groove is up to 30 millimeters.

Preferably, said groove side stop surface and said cam side stop surface extend with an angle of 90° to said middle axis.

Preferably, as seen in mounting direction before said at least one groove a cylindrical guiding surface is provided, wherein said at least one cam glides along said cylindrical guiding surface during the mounting process.

Preferably, said at least one groove is arranged on the housing and wherein said at least one cam is arranged on the cable gland; or wherein said at least one cam is arranged on the housing and wherein said at least one groove is arranged on the cable gland.

Preferably, the cable gland and/or the housing comprises stiffening ribs which enhance the stability of the cable gland.

Preferably, the cable gland and/or the housing are made out of a fibre-reinforced plastic.

An assembly comprising the housing assembly as described above, at least one electrical component that is arranged within said interior space and at least one cable that is in an electrical contact with said at least one electrical component and at least one sealing element which is held in said interior space by said cable gland.

Preferably, said at least one electrical component is a fuse. In this case two of said cables are arranged, wherein each of said cables is in an electrical contact with said fuse, wherein one of said cables is guided out of the interior space at one end and the other of said cables is guided out of the interior space at the other end. Both ends are provided with a cable gland. This embodiment is of particular advantage as the fuse is in line with the cables.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective exploded view of an a assembly comprising a housing assembly according to a preferred embodiment of the present invention;

FIG. 2 shows a sectional view of the housing assembly according to FIG. 1;

FIG. 3 shows a sectional view of the housing assembly according to FIG. 1;

FIG. 4 shows a perspective view of a cable gland of the housing assembly according to FIG. 1;

FIG. 5 shows a sectional view of the cable gland of FIG. 5; and

FIG. 6 shows a front view of the cable gland of FIGS. 4 and 5.

### DESCRIPTION OF PREFERRED EMBODIMENTS

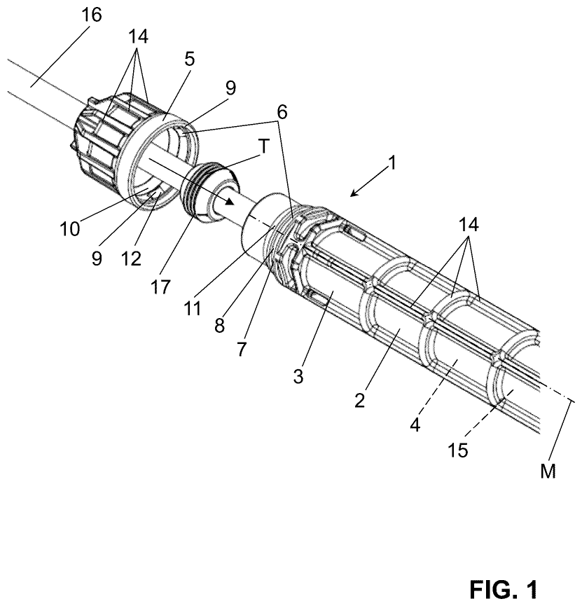

FIG. 1 shows an exploded view of an assembly comprising a housing assembly 1 and several other parts as it is outlined below.

The housing assembly 1 comprises a housing 2 and at least one cable gland 5. The at least one cable gland 5 is thereby mounted along a mounting direction T to the housing 2. The mounting direction is thereby collinear to the below mentioned middle axis M.

The housing 2 is provided with a housing wall 3 extending at least partly around a middle axis M. The housing wall 3 defines an interior space 4. In the interior space 4 at least one electrical component 15 can be placed. The electrical component 15 can be for example a fuse or an electrical contact element having a plug section or a socket section.

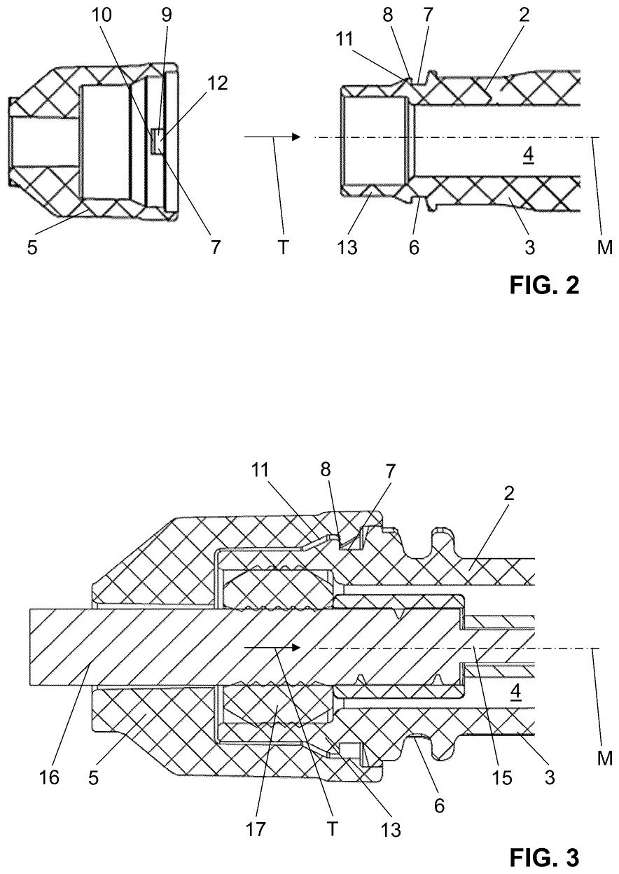

FIG. 2 shows an exploded view of the housing assembly 1 before mounting process and FIG. 3 shows the housing assembly 1 after the mounting process. The cable gland 5 can be mounted by means of a snap-in connection 6 to the housing 2. Said snap-in connection 6 comprises at least one groove 7 having a groove side strop surface 8 and at least one cam 9 having a cam side stop surface 10. In the shown embodiment the at least one groove 7 is located on the housing 2 and the at least one cam 9 is located on the cable gland 5. In the mounted position said at least one cam 9 engages in said at least one groove 7. Thereby said groove side stop surface 8 is in contact with said cam side stop surface 10. The contact between said groove side stop surface 8 and said cam side stop surface 10 is provided such that movement of the cable gland 5 against the mounting direction is prevented.

The contact between said groove side stop surface 8 and said cam side stop surface 10 is a flat contact which means that the surfaces contact each other in a preferably fully flat engagement. Said groove side stop surface 8 and said cam side stop surface 10 are oriented with an angle of 90° to the middle axis.

In other embodiments it is also possible to arrange the at least one groove 7 on the cable gland 5 and to arrange the at least one cam 9 on the housing 2.

The groove 7 in the present embodiment extends circumferentially around said middle axis M over the complete circumference. In the present case around the housing 2. Thereby the groove extends into the outer surface of the housing 2.

As seen in mounting direction an angularly inclined ramp section 11 is arranged before the groove 7. The angularly inclined ramp section 10 is provided such that the diameter of the angularly inclined ramp section 11 increases with decreasing distance to said groove 7. In other words: The angularly inclined ramp section 11 is provided as a cone stump. The angularly inclined ramp section 11 enhances the mounting process as the cam will be guided over the angularly inclined ramp section 11 before the engagement with the groove 7.

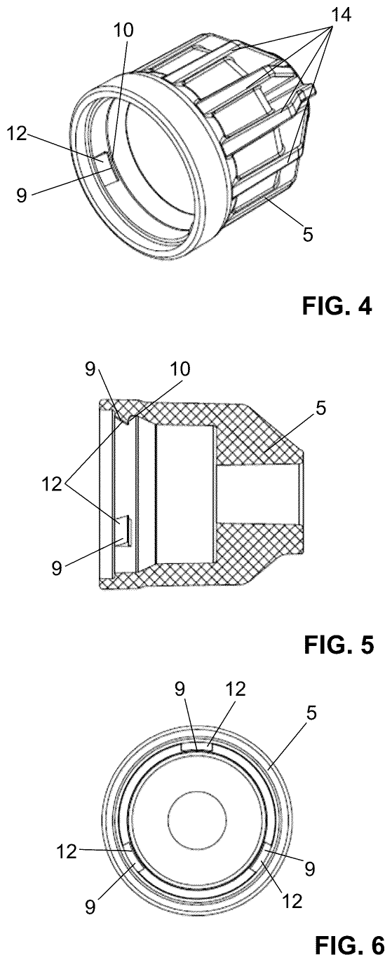

FIGS. 4 to 6 show various views of the cable gland 5. In the present embodiment the cable gland 5 comprises exactly three cams 9. The cams 9 are distributed in regular distances around the circumference around said middle axis M. With three cams this means the angle between two neighboring cams 5 is 120°. In the present case the cams 9 are located on an inner surface of the cable gland 5.

Said at least one cam 9 comprises an angularly inclined ramp section 12 which is arranged such that the diameter increases with increasing distance to said cam side stop surface 10. Said angularly inclined ramp section 12 will come into contact with the angularly inclined ramp section 10 of the groove 7. The two angularly inclined ramp section 10 and 12 come into contact with other and the angularly inclined ramp section 12 of the cable gland 5 glides over the angularly inclined ramp section 10 of the housing 2.

Furthermore, the housing comprises in the present embodiment a cylindrical guiding surface 13. As seen in mounting direction T, the cylindrical guiding surface 13 is arranged before said at least one groove 7. During the mounting process said at least one cam 9 glides along said cylindrical guiding surface 13.

Preferably, the cable gland 5 and/or the housing 2 comprises stiffening ribs 14 which enhance the stability of the cable gland 5.

The assembly as shown in FIG. 1 and also in FIG. 3 comprises the housing assembly as mentioned above. Furthermore, the assembly comprises at least one electrical component 15 that is arranged within said interior space 4 and at least one cable 16 that is in an electrical contact with said at least one electrical component and at least one sealing element 17 which is held in said interior space by said cable gland 5. Preferably the sealing surface of the housing is provided by the inner surface of the interior space 4. Preferably the interior space 4 is provided with a conical surface before the actual sealing surface such that the insertion of the sealing element is enhanced. The diameter of the conical surface decreases with closer distance to the sealing surface.

Preferably said at least one electrical component is a fuse. In this case two of said cables are arranged, wherein each of said cables is in an electrical contact with said fuse, wherein one of said cables is guided out of the interior space at one end and the other of said cables is guided out of the interior space at the other end. Both ends are provided with a cable gland 16.

### LIST OF REFERENCE SIGNS

1 housing assembly
2 housing
3 housing wall
4 interior space
5 cable gland
6 snap-in connection
7 groove
8 groove side stop surface
9 cam
10 cam side stop surface
11 angularly inclined ramp section
12 angularly inclined ramp section
13 cylindrical guiding surface
14 stiffening ribs
15 electrical component
16 cable
17 sealing element
M middle axis
T mounting direction

1-16. (canceled)

17. A housing assembly for an electrical component comprising
a housing with a housing wall extending at least partly around a middle axis and defining an interior space in which said electrical component can be placed, and
at least one cable gland which can be mounted to the housing along a mounting direction,
wherein said at least one cable gland is mounted by means of a snap-in connection to the housing,
wherein said snap-in connection comprising at least one groove having a groove side stop surface and at least one cam having a cam side stop surface,
wherein in the mounted position said at least one cam engages in said at least one groove and wherein said groove side stop surface is in contact with said cam side stop surface.

18. The housing assembly according to claim 17, wherein said at least one groove extends circumferentially around said middle axis over the complete circumference.

19. The housing assembly according to claim 17, wherein an angularly inclined ramp section is arranged before the groove as seen in mounting direction, wherein the angularly inclined ramp section is provided such that the diameter of the angularly inclined ramp section increases with decreasing distance to said groove.

20. The housing assembly according to claim 19, wherein said angularly inclined ramp section is inclined at an angle of 10° to 45°, in particular 15° to 35°, to the middle axis.

21. The housing assembly according to claim 17, wherein exactly one groove is arranged.

22. The housing assembly according to claim 17, wherein at least two or at least three or exactly three of said cams are arranged, which cams are distributed in regular distances around the circumference around said middle axis.

23. The housing assembly according to claim 17, wherein said at least one cam comprises an angularly inclined ramp section which is arranged such that the diameter increases with increasing distance to said cam side stop surface.

24. The housing assembly according to claim 23, wherein said angularly inclined ramp is inclined at an angle of 20° to 40°, in particular 25° to 35°, to the middle axis.

25. The housing assembly according to claim 17,
an angularly inclined ramp section is arranged before the groove as seen in mounting direction, wherein the angularly inclined ramp section is provided such that the diameter of the angularly inclined ramp section increases with decreasing distance to said groove; and wherein said at least one cam comprises an angularly inclined ramp section which is arranged such that the diameter increases with increasing distance to said cam side stop surface
wherein said angularly inclined ramp sections have the same angle with respect to said middle axis; or wherein said angularly inclined ramp section located at the groove has a larger or smaller angle with respect to the middle axis as said angularly inclined ramp section located at the cam.

26. The housing assembly according to claim 25, wherein said angularly inclined ramp section is inclined at an angle of 10° to 45°, in particular 15° to 35°, to the middle axis; or wherein said angularly inclined ramp is inclined at an angle of 20° to 40°, in particular 25° to 35°, to the middle axis.

27. The housing assembly according to claim 17, wherein said groove side stop surface is in a flat contact with said cam side stop surface.

28. The housing assembly according to claim 17, wherein said groove side stop surface and said cam side stop surface extend with an angle of 90° to said middle axis.

29. The housing assembly according to claim 17, wherein as seen in mounting direction before said at least one groove a cylindrical guiding surface is provided, wherein said at least one cam glides along said cylindrical guiding surface during the mounting process.

30. The housing assembly according to claim 17, wherein said at least one groove is arranged on the housing and wherein said at least one cam is arranged on the cable gland; or wherein said at least one cam is arranged on the housing and wherein said at least one groove is arranged on the cable gland.

31. The housing assembly according to claim 17, wherein the cable gland and/or the housing comprises stiffening ribs which enhance the stability of the cable gland.

32. An assembly comprising a housing assembly at least one electrical component at least one cable and at least one sealing element,
wherein the housing assembly comprises a housing with a housing wall extending at least partly around a middle axis and defining an interior space in which said electrical component can be placed, and at least one cable gland which can be mounted to the housing along a mounting direction, wherein said at least one cable gland is mounted by means of a snap-in connection to the housing, wherein said snap-in connection comprising at least one groove having a groove side stop surface and at least one cam having a cam side stop surface, and wherein in the mounted position said at least one cam engages in said at least one groove and wherein said groove side stop surface is in contact with said cam side stop surface, and
wherein the at least one electrical component is arranged within said interior space and
wherein the least one cable is in an electrical contact with said at least one electrical component and
wherein the at least one sealing element is held in said interior space by said cable gland.

33. The assembly according to claim 32, wherein said at least one electrical component is a fuse and wherein two of said cables are arranged, wherein each of said cables is in an electrical contact with said fuse, wherein one of said cables is guided out of the interior space at one end and the other of said cables is guided out of the interior space at the other end, wherein both ends are provided with a cable gland.
